(19) United States
(12) Patent Application Publication
(10) Pub. No.: US 2018/0135486 A1
(43) Pub. Date: May 17, 2018

(54) REFORMING SYSTEM AND REFORMER OPERATING METHOD USING TEMPERATURE SENSOR

(71) Applicants: Hyundai Motor Company, Seoul (KR); Kia Motors Corporation, Seoul (KR)

(72) Inventors: Hong Kil BAEK, Seoul (KR); Seung Woo LEE, Seoul (KR); Tae Won LEE, Incheon (KR)

(73) Assignees: Hyundai Motor Company, Seoul (KR); Kia Motors Corporation, Seoul (KR)

(21) Appl. No.: 15/614,444

(22) Filed: Jun. 5, 2017

(30) Foreign Application Priority Data
Nov. 15, 2016 (KR) 10-2016-0152006

(51) Int. Cl. F01N 3/08; C01B 3/36; F02D 41/02

(52) U.S. Cl. CPC F01N 3/0885; F02D 41/0065; F02D 41/024; C01B 3/366

(57) ABSTRACT

A reforming system may include an engine combusting reformed gas to generate mechanical power, an intake line connected to the engine to supply reformed gas and air to the engine, an exhaust line connected to the engine to circulate exhaust gas exhausted from the engine, a reformer provided at an exhaust gas recirculation (EGR) line diverging from the exhaust line and mixing the exhaust gas with fuel to reform the fuel mixed with the exhaust gas, a temperature sensor provided in the reformer and measuring temperature of the reformer, and a reforming controller determining whether the reformer operates or not based on driving condition of the engine and temperature of the reformer.

### CROSS-REFERENCE(S) TO RELATED APPLICATIONS

The present application claims priority to Korean Patent Application No. 10-2016-0152006 filed on Nov. 15, 2016, the entire contents of which are incorporated herein for all purposes by this reference.

### BACKGROUND OF THE INVENTION

### Field of the Invention

The present invention relates to a reforming system and reformer operating method using a temperature sensor. More particularly, the present invention relates to a reforming system which determines whether the reformer operates or not using the temperature of the reformer, and a reformer operating method.

### Description of Related art

Generally, an exhaust gas recirculation (EGR) system is a system which is disposed in a vehicle and configured for decreasing the total noxious exhaust gas expelled from the vehicle.

The present EGR system is configured to reduce the amount of oxygen in a mixer by circulating part of the exhaust gas expelled from the engine, therein reducing the volume of exhaust gas while also reducing the toxic matters in the exhaust gas.

Also, the exhaust gas expelled from the engine has a high temperature; therefore the engine efficiency may be improved by utilizing the thermal energy of the exhaust gas.

Meanwhile, a fuel reformer is a device which changes fuel characteristics by use of a catalyst. A fuel reformer may be applied to increase combustion efficiency or activating a post processing system.

By the present case, the reforming efficiency is too low and the catalyst may be degraded or damaged as the reformer operates in a region where the reforming catalyst temperature is low.

The information disclosed in this Background of the Invention section is only for enhancement of understanding of the general background of the invention should not be taken as an acknowledgement or any form of suggestion that this information forms the prior art t already known to a person skilled in the art.

### BRIEF SUMMARY

Various aspects of the present invention are directed to providing a reforming system and a reformer operating method that may determine whether or not the reformer operates. The reform's operation status is determined on the basis of the reformer temperature when the driving condition of the engine is in a driving region that is able to reform.

A reforming system according to an exemplary embodiment of the present invention includes an engine which combusts reformed gas to generate mechanical power, an intake line connected to the engine which supplies reformed gas and air, an exhaust line connected to the engine which circulates exhaust gas expelled from the engine, a reformer disposed on an EGR line which diverges from the exhaust line and mixes the exhaust gas with fuel to reform the fuel, a temperature sensor disposed in the reformer configured to measure the temperature of the reformer, and a reforming controller configured to determine whether the reformer operates, or not, based on the driving condition of the engine and the temperature of the reformer.

The reforming system according to an exemplary embodiment of the present invention may further include a compressor connected to the intake line which compresses the reformed gas and air before being supplied to the engine, and a turbine connected to the exhaust line which rotates by the exhaust gas therein generating useable power.

The reforming system according to an exemplary embodiment of the present invention may further include a catalyst disposed at the exhaust line of the rear portion of the EGR line, and purifying the nitrogen oxide included in the exhaust gas.

The catalyst may include a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide.

The catalyst may include a selective catalytic reducer (SCR) restoring the nitrogen oxide included in the exhaust gas by using a reducing agent.

An EGR cooler which cools the reformed gas and an EGR valve disposed at a rear end portion of the EGR cooler which adjusts the flow rate of the reformed gas may be disposed at the EGR line.

The reformer may be disposed at a front portion of the EGR cooler in the EGR line.

The reforming controller may operate the reformer when the driving condition of the engine is in a driving region that is configured to reform, and the catalyst temperature of the reformer measured by the temperature sensor exceeds a target temperature.

The driving condition of the engine may be classified by the revolutions per minute (RPM) of the engine and engine torque.

Meanwhile, reformer operating method according to an exemplary embodiment of the present invention includes detecting the driving condition of an engine, determining whether or not the driving condition of the engine is in a driving region that is configured to reform, measuring the temperature of a reformer, comparing the temperature of the reformer with a target temperature when the driving condition of the engine is in the driving region that is configured to reform, and operating the reformer when the reformer temperature exceeds the target temperature.

The reformer operating method according to an exemplary embodiment of the present invention may further include stopping the operation of the reformer when the reformer temperature is below the target temperature.

According to an exemplary embodiment of the present invention, reforming efficiency may be maximized by operating a fuel reformer in a high temperature region above a target temperature.

The fuel reformer is also configured to only operate in a high temperature region wherein catalyst deterioration or damage in the reformer is generated when the reforming reaction does not occur in a low temperature region.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1 is a schematic view illustrating a reforming system according to an exemplary embodiment of the present invention.

FIG. 2 is a flowchart illustrating a reformer operating method according to an exemplary embodiment of the present invention.

FIG. 3 is a graph illustrating a driving region that is configured to reform in a driving condition of an engine according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It will be understood that when an element including a layer, film, region, or substrate is referred to as being “on” another element, it can be directly on the other element or intervening elements may also be present.

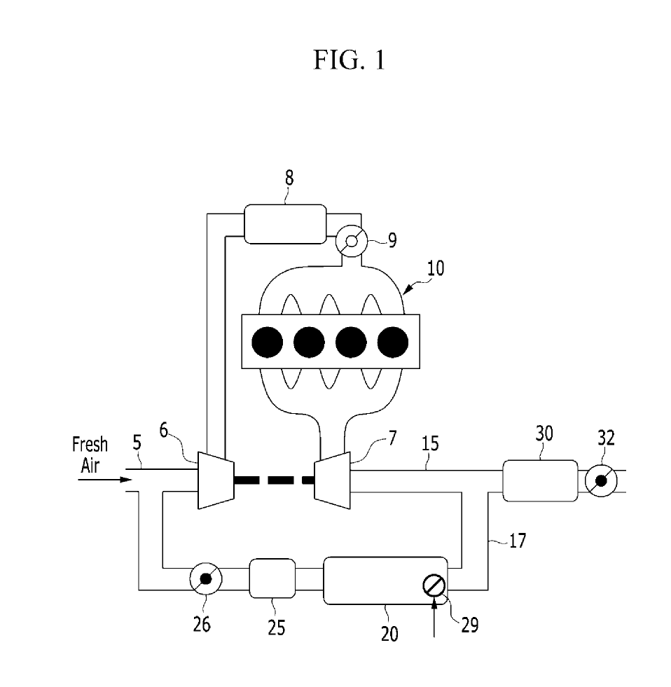

A reforming system according to an exemplary embodiment of the present invention will be described with reference to FIG. 1.

FIG. 1 is a schematic view illustrating a reforming system according to an exemplary embodiment of the present invention.

Referring to FIG. 1, a reforming system includes an engine 10, an intake line 5, an exhaust line 15, a reformer 20, a temperature sensor 29, and a reforming controller.

The engine 10 burns an air-fuel mixture in which fuel and air are combined to convert chemical energy into mechanical energy. The engine 10 is connected to an intake manifold to receive air in a combustion chamber, and is connected to an exhaust manifold wherein exhaust gas generated in the combustion process is gathered in the exhaust manifold and is discharged to the external. An injector is mounted in the combustion chamber to inject the fuel into the combustion chamber.

A diesel engine is exemplified herein, but a lean-burn gasoline engine may be used. In the case that the gasoline engine is used, the air-fuel mixture flows into the combustion chamber through the intake manifold and a spark plug is mounted at an upper portion of the combustion chamber. In addition, when a gasoline direct injection (GDI) engine is used, the injector is mounted at the upper portion of the combustion chamber.

In addition, as engines have various compression ratios, preferably a compression ratio lower than or equal to 16.5 may be used.

The intake line 5 is connected to the entrance of engine 10 and supplies reformed gas and air to the engine 10, and the exhaust line 15 is connected to the exit of engine 10 and circulates exhaust gas discharged from the engine 10.

A portion of the exhaust gas discharged from the engine is resupplied to the engine 10 through the EGR line 17. The EGR line 17 is connected to the intake manifold so that the combustion temperature is controlled by mixing a portion of the exhaust gas with air. The present combustion temperature control is operated by adjusting the amount of exhaust gas supplied to the intake manifold. Accordingly, EGR valve 26 which adjusts the flow rate of the reformed gas may be disposed on the EGR line 17.

An EGR system manifested by the EGR line 17 supplies a portion of the exhaust gas to the intake system and inflows to combustion chamber when the amount of nitrogen oxide exhaust needs to be reduced according to the driving condition. Then, the exhaust gas that is inert gas, whose volume is not changed, lowers the density of the air-fuel mixture and flame transmitting speed is reduced during the combustion of the fuel. Therefore, combustion velocity of the fuel is reduced and the combustion temperature is reduced to depress generation of nitrogen oxide.

The reformer 20 is disposed on the EGR line 17 diverging from the exhaust line 15 and mixes the exhaust gas with fuel to reform the fuel mixed with the exhaust gas.

The reformer 20 may include an inlet where the exhaust gas inflows, a mixing portion where the exhaust gas and fuel are mixed, a reforming portion where fuel is reformed, and an outlet where the reformed gas outflows.

The temperature sensor 29 is disposed in the reformer 20 and may measure temperature of the reformer 20.

Meanwhile, the reforming system according to an exemplary embodiment of the present invention may further include a compressor 6 connected to the intake line 5 which compresses the reformed gas and air supplied to the engine 10, and a turbine 7 connected to the exhaust line 15 which rotates from the exhaust gas to generate power.

The reforming system may also include an intercooler 8 connected to the compressor 6 which cools air and reformed gas circulated into the intake line 5 of the engine 10 again, and a throttle valve 9 configured to adjust the flow rate of air and reformed gas.

The reforming system according to an exemplary embodiment of the present invention may further include a catalyst 30 disposed on the exhaust line 15 of rear portion of the EGR line 17 configured to purify nitrogen oxide in the exhaust gas.

The catalyst 30 may include a LNT which traps the nitrogen oxide included in the exhaust gas in a lean condition while desorbing the trapped nitrogen in a rich condition, and restores the nitrogen oxide included in the exhaust gas or the desorbed nitrogen oxide. The LNT may oxidize carbon monoxide (CO) and hydrocarbon (HC) included in the exhaust gas. Here, it should be understood that hydrocarbon is used to imply a compound which includes carbon and hydrogen in exhaust gas and fuel.

The catalyst 30 may further include a SCR restoring the nitrogen oxide included in the exhaust gas by using a reducing agent. The reducing agent may be urea injected from an injection module.

An exhaust pressure control valve 32 configured to adjust the flow rate of exhaust gas may be disposed at a rear end portion of the catalyst 30 in the exhaust line 15.

Meanwhile, at the EGR line 17, an EGR cooler 25 which cools the reformed gas, and an EGR valve 26 disposed at a rear end portion of the EGR cooler 25 configured to adjust the flow rate of reformed gas may be disposed.

At the present time, the reformer 20 may be disposed at a front portion of the EGR cooler 25 in the EGR line 17.

The reforming controller is configured to determine whether the reformer operates, or not, based on the driving condition of the engine 10 and the temperature of the reformer 20.

The reforming controller operates the reformer when the driving condition of the engine 10 is in a driving region that is configured to reform, and the catalyst temperature of the reformer 20 measured by the temperature sensor 29 exceeds a target temperature.

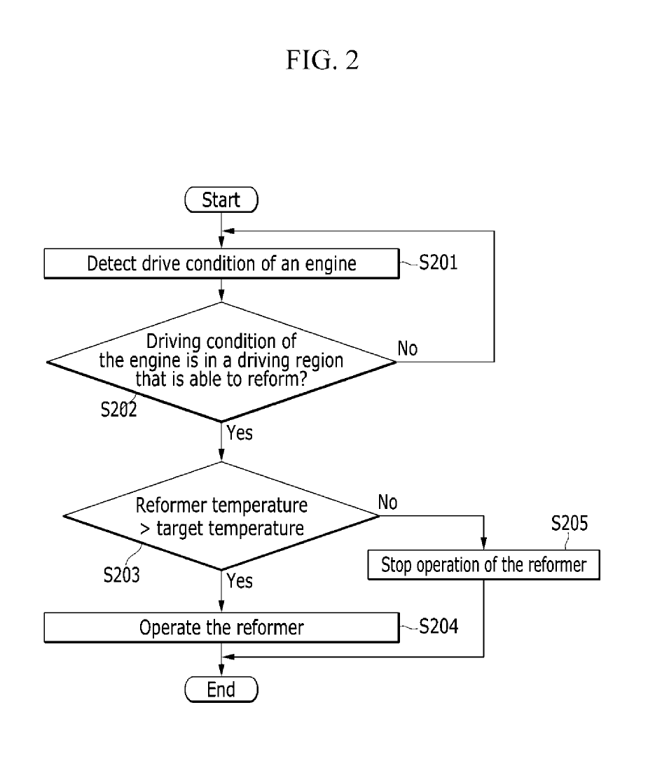

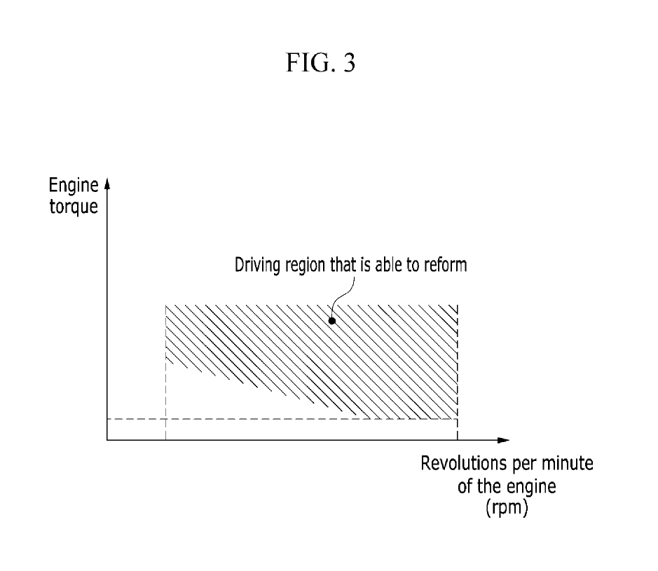

FIG. 2 is a flowchart illustrating a reformer operating method according to an exemplary embodiment of the present invention. FIG. 3 is a graph illustrating a driving region that is configured to reform in a driving condition of the engine according to an exemplary embodiment of the present invention.

Referring to FIG. 2, in the reformer operating method the driving condition of an engine is detected first (S201). The driving condition of the engine may be the RPM of the engine, engine torque, idle state, normal speed, reduced speed, and or accelerated speed state etc.

After that the previous step, it is determined whether or not the driving condition of the engine is in a driving region that is configured to reform (S202). As shown in FIG. 3, the RPM of the engine and engine torque may be examples for driving conditions of the engine. As the RPM of the engine and engine torque increase the temperature of the exhaust gas and catalyst increases. In a region where the reformer catalyst has high temperature, high efficient driving of the reformer is possible. The driving region that is configured to reform is predetermined by considering the RPM and the torque of the engine, and it is determined whether or not the driving condition of the engine is in the predetermined region.

Next, the temperature of the reformer catalyst is measured, and when the driving condition of the engine is in the driving region that is configured to reform the reformer temperature and a target temperature are compared (S203).

The target temperature may be set by experimentation as a temperature where reforming efficiency increases rapidly. For example, the target temperature may be approximately 480° C. to approximately 520° C.

Following the previous step, the reformer operates when the reformer temperature exceeds the target temperature (S204). Operation of the reformer ceases when the reformer temperature is below the target temperature (S205).

Like the present case, according to an exemplary embodiment of the present invention reforming efficiency may be maximized by operating a fuel reformer in a high temperature region above a target temperature.

The fuel reformer operates only in a high temperature region wherein catalyst deterioration or damage in the reformer is generated when the reforming reaction does not occur in a low temperature region.

For convenience in explanation and accurate definition in the appended claims, the terms “upper”, “lower”, “internal”, “outer”, “up”, “down”, “upwards”, “downwards”, “front”, “back”, “rear”, “inside”, “outside”, “inwardly”, “outwardly”, “internal”, “external”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A reforming system, comprising:
an engine combusting reformed gas to generate mechanical power;
an intake line connected to the engine to supply reformed gas and air to the engine;
an exhaust line connected to the engine to circulate exhaust gas exhausted from the engine;
a reformer provided at an exhaust gas recirculation (EGR) line diverging from the exhaust line and mixing the exhaust gas with fuel to reform the fuel mixed with the exhaust gas;
a temperature sensor provided in the reformer and measuring temperature of the reformer; and
a controller determining whether the reformer operates or not based on driving condition of the engine and temperature of the reformer.

2. The reforming system of claim 1, further comprising:
a compressor connected to the intake line and configured to compress the reformed gas and air to supply to the engine; and
a turbine connected to the exhaust line and rotating by the exhaust gas to generate power.

3. The reforming system of claim 1, further comprising:
a catalyst disposed at the exhaust line of a rear portion of the EGR line and purifying a nitrogen oxide included in the exhaust gas.

4. The reforming system of claim 3, wherein
the catalyst includes a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide.

5. The reforming system of claim 3, wherein
the catalyst includes a selective catalytic reducer (SCR) restoring the nitrogen oxide included in the exhaust gas by using a reducing agent.

6. The reforming system of claim 1, wherein at the EGR line, an EGR cooler cooling the reformed gas, and an EGR valve disposed at a rear end portion of the EGR cooler and adjusting flow rate of the reformed gas are disposed.

7. The reforming system of claim 6, wherein the reformer is disposed at a front portion of the EGR cooler in the EGR line.

8. The reforming system of claim 1, wherein the controller is configured to operate the reformer when the driving condition of the engine is in a driving region that is configured to reform, and catalyst temperature of the reformer measured by the temperature sensor exceeds a target temperature.

9. The reforming system of claim 1, wherein
the driving condition of the engine is revolutions per minute (RPM) of the engine and an engine torque.

10. Reformer operating method, comprising:
detecting driving condition of an engine;
determining whether the driving condition of the engine is in a driving region that is configured to reform;
measuring temperature of a reformer;
comparing the temperature of the reformer with a target temperature when the driving condition of the engine is in the driving region that is configured to reform; and
operating the reformer when the reformer temperature exceeds the target temperature.

11. The reformer operating method of claim 10, further including:
stopping operation of the reformer when the reformer temperature is below the target temperature.
